(19) United States
(12) Patent Application Publication
(10) Pub. No.: US 2026/0126093 A1
(43) Pub. Date: May 7, 2026

(54) DAMPING CYLINDER ASSEMBLY

(71) Applicant: BÜMACH ENGINEERING INTERNATIONAL B.V., TA Emmen (NL)

(72) Inventor: Josef BUETER, Haren/Altenberge (DE)

(21) Appl. No.: 19/117,157

(22) PCT Filed: Sep. 4, 2023
(86) PCT No.: PCT/DE2023/000103

§ 371 Date: Mar. 31, 2025

(30) Foreign Application Priority Data
Oct. 11, 2022 (DE) 20 2022 002 220.4

(51) Int. Cl. F16F 9/06

(52) U.S. Cl. CPC F16F 9/065; F16F 9/061; F16F 2222/12; F16F 2226/048; F16F 2232/08; F16F 2234/02

(57) ABSTRACT

A damping cylinder assembly has a cylinder, a damping accumulator and a base closure part. The cylinder has a closure part, a piston unit, a cylinder pipe with a guide-side cylinder pipe end and a base-side cylinder pipe end. The closure part is located on the guide-side cylinder pipe end. The base closure part has a cylinder pipe receiving portion, a damping accumulator receiving portion and a fluid channel that connects the cylinder pipe receiving portion and the accumulator receiving portion. The piston unit slidingly passes through the guide closure part and, together with the cylinder pipe and the base closure part define-a working space connected to the fluid channel. The accumulator has a pressure capsule and a fluid connection to the fluid channel.

The invention relates to a damping cylinder assembly, for demanding fields of application with high dynamic load, such as in agricultural machinery engineering, in particular.

In the prior art it is known to provide damping systems that use heavy pressure springs, for example, in agricultural machinery engineering in soil cultivation. This solution is disadvantageous due to the low absorbable force and the poor characteristic curve.

Hydraulic damping cylinders have proven to be more advantageous in the state of the art. This advantage applies in particular, if they are equipped with a diaphragm accumulator or a bladder accumulator. The high dynamic loads and the occurring pressure peaks that require particularly strong couplings are problematic. A disadvantage is the complex production required for this design, since extensive machining is necessary to manufacture the damping cylinder and the high thermal stresses associated with MAG welding, for example, can have a negative impact on quality and service life and require a high energy input. Furthermore, cleaning of the cylinder interior is disadvantageously required after MAG welding. Therefore, the alternative solution to couple the guide closure part by means of a screw connection is known in the art.

The task of the invention is to provide a damping cylinder assembly that can be produced in a resource-saving manner, at high quality and in short time.

The task is solved by the features listed in claim 1. Preferred further developments result from the sub-claims.

The damping cylinder assembly according to the invention comprises a hydraulic cylinder and a damping accumulator as its basic components. The hydraulic cylinder acts as a pressure generator during a retraction movement and as a pressure consumer during an extension movement. During the retraction movement, which is effected by a force introduced by a coupled device component and which shall be performed in a damped manner, a fluid flow is generated and the fluid is pressed into the damping cylinder and received there. Conversely, during an extension movement, the fluid is discharged out of the damping accumulator under pressure and received by the hydraulic cylinder. In at least one movement direction of the fluid, the fluid flow is throttled and, thus, damping is caused. The hydraulic cylinder and the damping accumulator are hereinafter collectively referred to as the hydraulic units.

The hydraulic cylinder comprises a cylinder pipe (hereinafter referred to as cylinder tube), a guide closure part, a base closure part and a piston unit.

In this design, the cylinder tube comprises a guide-side cylinder tube end and a base-side cylinder tube end. The guide closure part is arranged at the guide-side cylinder tube end.

The base closure part of the hydraulic cylinder is designed in a particular manner and comprises both a cylinder tube receiving portion, a damping accumulator receiving portion and a fluid channel.

The cylinder tube is arranged with its base-side cylinder tube end at the cylinder tube receiving portion and forms a base-side axial boundary of the cylinder interior which is opposite the guide-side axial boundary of the cylinder interior.

The piston unit slidingly passes through the guide closure part and, together with the cylinder tube and the base closure part, forms a working chamber. This working chamber is connected to the fluid channel so that, during a retraction movement, the fluid is displaced out of the decreasing working chamber and pressed into the fluid channel and, conversely, can flow into the working chamber via the fluid channel and cause an extension movement. The piston unit can be designed, in particular, as a unit consisting of a piston and a piston rod. However, it can also be designed as a plunger piston so that in this case the hydraulic cylinder is provided as a plunger cylinder.

The fluid channel provided in the base closure part connects the cylinder tube receiving portion and the damping accumulator receiving portion.

The damping accumulator comprises a pressure capsule and, accommodated by the pressure capsule, a fluid chamber and a pressure-deformable air chamber separated from the fluid chamber by a membrane. In this design, a pressure-deformable membrane-separated air chamber is understood to be a structural design in which, depending on the fluid pressure, a compression of the air enclosed in the air chamber is effected and, thus a preload of the air is produced which acts on the fluid. The compression causes a reduction in the volume of the air chamber so that the fluid chamber can receive correspondingly more fluid. Preferably, a diaphragm accumulator is used, although other constructive designs, such as a metal bellows accumulator, are also covered by the solution according to the invention.

The damping accumulator further comprises a damping accumulator fluid connection, which is arranged at the base closure part. There, the damping accumulator is coupled to the base closure part in such a way that a sealing connection is produced and a fixed positional relationship is simultaneously established between the base closure part and the damping accumulator. This coupling can preferably be designed as a laser welded joint.

The base closure part is in functional integration such that, firstly, it forms the working chamber of the hydraulic cylinder, secondly, it acts as a basic body for power transmission and for mounting, for example, on a machine part, and thirdly, it functions as a carrier for the damping accumulator.

The damping fluid connection is connected to the fluid channel of the base closure part in a fluid-conducting manner such that the fluid displaced out of the hydraulic cylinder during a retraction movement can be pressed into the damping cylinder via this path and, conversely, can be returned during an extension movement.

The damping cylinder assembly according to the invention is particularly characterized in that a combination of two beam welding methods is used in the manufacture of a hydraulic unit, which consists of the hydraulic cylinder and the damping accumulator and, thus, of two different hydraulic units, to provide the non-detachable coupling of them.

It was found that the combination of two beam welding methods, which are both based on the application of high-energy radiation to the coupling partners but, at the same time, can satisfy different specific requirements as electron beam welding and laser beam welding processes, provides both a particularly high-quality and energy-efficient production of a damping cylinder unit. This advantageously allows to meet the special conditions based on the different functions and design features of the two hydraulic units.

For this purpose, the damping cylinder unit is characterized in that, according to the invention, the damping accumulator is welded at its pressure capsule by means of an electron beam ring weld seam. Optionally, several electron beam weld seams can be produced on the damping accumulator.

Furthermore, the damping cylinder assembly is characterized in that the guide closure part is connected to the cylinder tube in a positive substance manner by means of a first circumferential laser ring weld seam, and in that the base closure part is connected to the cylinder tube in a positive substance manner by means of a second circumferential laser ring weld seam.

The coupling according to the invention by means of two circumferential laser ring weld seams makes it possible for the first time to manufacture the hydraulic cylinder—a including its components that have only a limited thermal load-bearing capacity, such as piston seals and guides on the piston or on the guide closure part—with such a high level of quality assurance that there is no need to provide access for maintenance, for example, by screw-coupling the guide closure part. Whereas, due to the extremely high dynamic loads by the connected components to be damped, particularly massive MAG welding joints between the cylinder tube and the base closure part were required according to the state of the art and placed a massive thermal load on the coupling partners, a way was surprisingly found in the present invention to apply laser welding by means of the special arrangement of the laser ring weld seams.

Preferably, the first laser ring weld seam is a radial and butt-jointed seam and the second laser ring weld seam is a conical seam with an angle of inclination.

According to the invention, the electron beam welding method on the damping accumulator and the laser welding method on the hydraulic cylinder are advantageously combined in the damping cylinder assembly. The combination of electron beam welding and laser welding has provided a solution that enables a time- and energy-saving manufacturing process and simultaneously ensures a high-quality and process-reliable production of a damping cylinder assembly.

The advantage of this combination is based on the fact that, on the one hand, the laser beam welding method is energetically advantageous for smaller weld seams, especially also smaller than 5 mm, whereas, on the other hand, the electron beam welding method can achieve a high level of energy efficiency when welding larger seams, such as those used in the manufacture of the damping accumulator. In addition, the electron beam welding method is easier to control so that it is possible to adjust the power density. Furthermore, the advantages given by the combination of the two beam welding methods cannot be achieved by using only one of them.

Furthermore, a particular advantage in terms of production technology is the fact that process-related and occupational safety-related provisions for one of the welding processes, such as an enclosure of the process area or a shield, can be used at the same time for the other welding method so that multiple protection measures can be avoided.

Laser welding offers the advantage that the cylinder tube can be designed with a smaller wall thickness, since otherwise allowances required according to the prior art to compensate for thread material removal can be dispensed with. The elimination of the requirement of minimum lengths for thread sections also makes it possible to achieve shorter construction lengths of the cylinder tube.

The damping cylinder assembly according to the invention can be used in a wide range of applications, in particular in agricultural machinery, vehicles and in mechanical engineering.

According to an advantageous further development, the damping cylinder assembly is characterized in that the cylinder tube receiving portion of the base closure part has a conical receiving contour, and in that the cylinder tube has a corresponding conical ring surface, and in that the second laser ring weld seam is formed with a laser weld seam inclination angle which is 20 to 70 degrees. Due to the conical receiving contour and the corresponding conical ring surface, two surfaces are opposite to each other in a substantially gap-free manner so that the laser, with an appropriately coordinated penetration depth, produces full-surface welding with a simultaneously low energy input per unit length.

According to this advantageous further development, the cylinder tube comprises an end portion with an axial ring surface that protrudes the conical ring surface in an axially distal manner. This axial ring surface abuts against an axial mating ring surface of the cylinder tube receiving portion.

In a further advantageous development, the distally projecting end portion has a wall thickness that is reduced in comparison to the wall thickness of the cylinder tube. Preferably, the wall thickness of the distally projecting end portion is between 10 and 30 per cent of the full wall thickness of the cylinder tube. In addition, the distally protruding end portion forms an outer lateral surface radially on the outside, which abuts against an opposing inner lateral surface of the cylinder tube receiving portion.

These further developments have the particular advantages described in the following. The conical receiving contour on the base closure part and the corresponding conical ring surface on the cylinder tube can be advantageously produced in a simple manner and with little material removal by means of a turning-milling process. From a manufacturing point of view, it is advantageous that this process simultaneously enables a self-centring joining of the cylinder tube with the base closure part to form a preliminary assembly group prior to laser welding. In addition, the length of the distally protruding end portion is preferably selected such that, when joining takes place, this portion is brought into an axially preloaded state by means of elastic compression when the conical receiving contour and the conical ring surface abut against each other in an assembly position thus being ready for welding. Subsequently, laser welding is carried out. The elastic preload is also maintained after the laser welding process has been finished. It is advantageous that the axial ring surface is already in metallic-sealing contact with the axial mating ring surface during welding so that the cylinder interior is reliably protected against contamination during the welding process. Welding at the conical surface pairing with a laser weld seam inclination angle advantageously creates a larger weld seam area, provides unhindered spatial access for the laser to the weld seam, and, in combination with the distally protruding end portion, ensures that the weld seam root does not come into contact with the cylinder interior.

As a particular advantage, the geometry of the conical receiving contour of the base closure part and its continuation at the inner lateral surface in conjunction with the conical ring surface and its continuation by the outer lateral surface and the distally protruding end portion also enables a particularly stable coupling despite the high dynamic loads. The pressure fluctuations with sudden pressure peaks occurring during the impacts to be damped load the coupling. Moreover, there is a barrier as a result of the preload on the axial ring surfaces that separates the fluid from the second laser ring weld seam. Furthermore, the fluid acts radially on the inner surface of the distally protruding end portion. Here, it is particularly advantageous that, on the one hand, the reduced wall thickness of the distally protruding end portion allows for its elastic compression and prestressing and, on the other hand, this section is pressed outwards against the inner lateral surface of the cylinder tube receiving portion by pressure peaks during the radial application of force, and thus, in this operating state, increased lateral friction is resulting between the outer lateral surface of the distally protruding end portion and the inner lateral surface, and the distally projecting end portion is radially supported. These factors together effectively reduce the load on the laser weld seam.

According to a further advantageous development, the damping cylinder assembly is characterized in that the guide closure part has a graduated hollow-cylindrical receiving contour, in that a radial outer ring surface of the hollow-cylindrical receiving contour abuts against an inner lateral surface of the cylinder tube, and in that the guide closure part comprises a proximal axial ring surface, which, together with a distal axial mating ring surface of the cylinder tube, forms the first laser ring weld seam in a butt-jointed manner.

This further advantageous development relates to the formation of the coupling between the guide closure part and the cylinder tube and, thus, applies to the first laser ring weld.

The outer radial ring surfaces of the hollow-cylindrical receiving contour and the inner lateral surface of the cylinder tube advantageously form a separation that prevents a direct connection of the first laser weld seam, including its weld seam root, to the cylinder interior so that contamination of the interior during welding is prevented here, too. Furthermore, the radial form fit supports the coupling of the guide closure part to the cylinder tube.

The invention is explained as an exemplary embodiment in more detail by the following figures. They show:

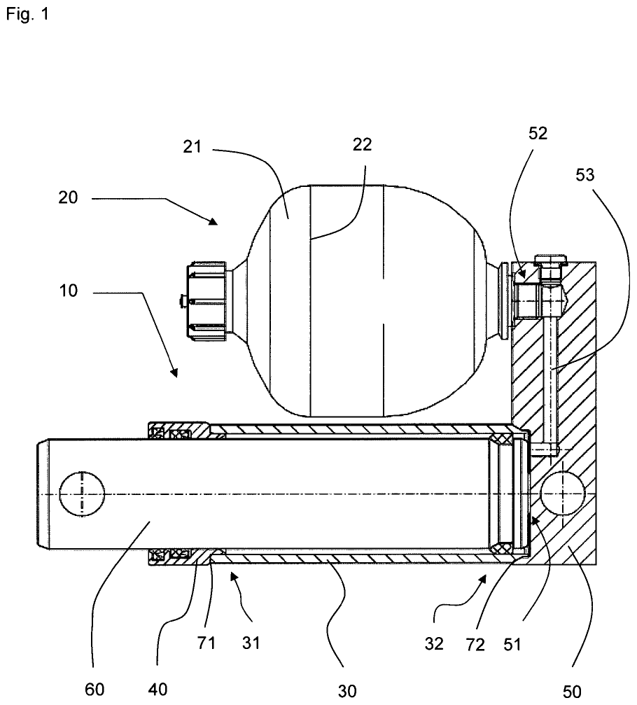

FIG. 1 Longitudinal section of a damping cylinder assembly

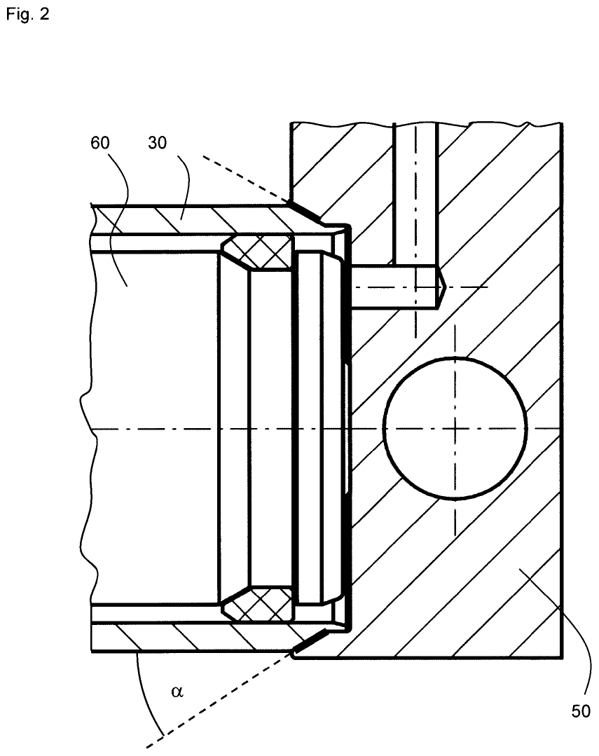

FIG. 2 Enlarged section of the base-side cylinder portion

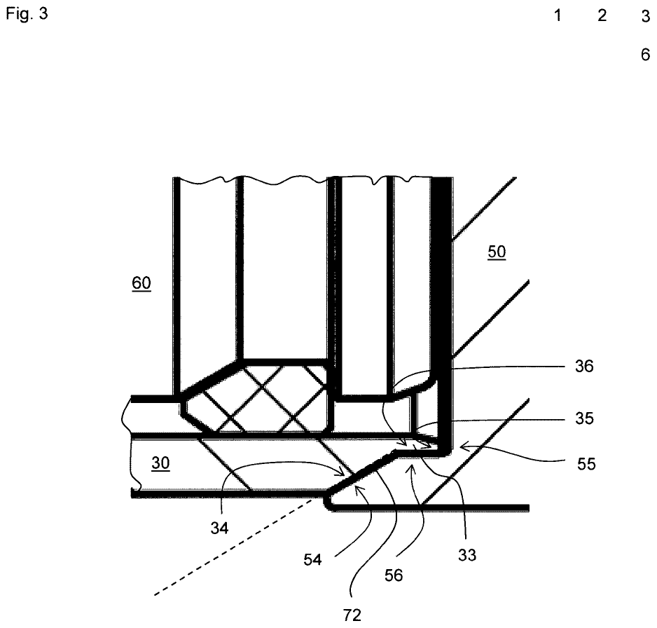

FIG. 3 Enlarged section of the area of the second laser ring weld seam

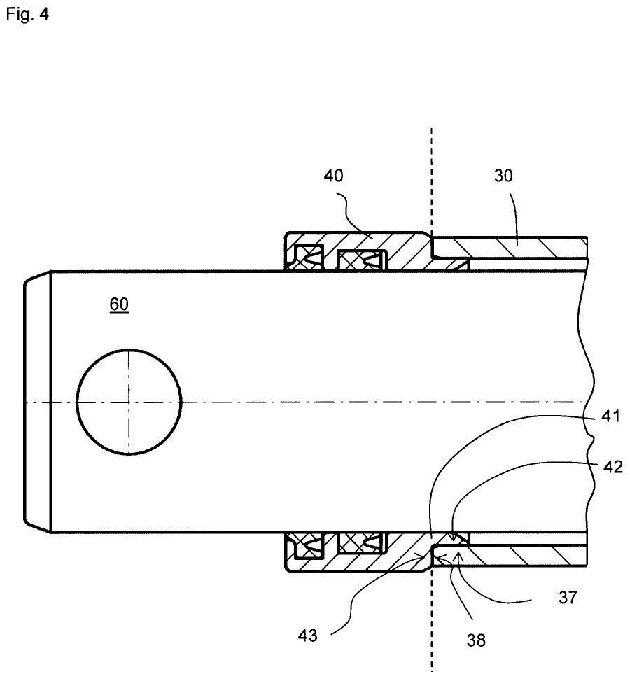

FIG. 4 Enlarged section of the guide-side cylinder portion.

The same reference numerals in the various figures always refer to the same features or components. The reference numerals are also used in the description, if they are not shown in the figure in question.

FIG. 1 shows an embodiment in which the hydraulic cylinder 10 and the damping accumulator 20 as the basic components are in the positional relationship defined by the base closure part 50.

In this embodiment, the base closure part 50 is produced as a so-called flame-cut part and the cylinder tube receiving portion 51, the damping accumulator receiving portion 52 and the fluid channel 53 are produced in a subtractive machining process. A filling and venting opening (without reference numeral) is assigned to the fluid channel at the top.

The hydraulic cylinder 10 is formed by the cylinder tube 30 together with the guide closure part 40 arranged at its guide-side cylinder tube end 31, the base closure part 50 arranged at its base-side cylinder tube end 32 and the piston unit 60, which is provided as a plunger piston here.

In this exemplary embodiment, the damping accumulator 20 is designed as a diaphragm accumulator and, in its pressure capsule 21, it comprises a diaphragm (not shown) which separates an air chamber from the fluid in a fluid chamber, wherein the air chamber is compressible by means of the fluid pressure and, depending on the pressure and the resulting degree of compression, the volume of the fluid chamber is increased.

According to the invented combination of two different kinds of beam weld seams, both laser beam welding and electron beam welding is applied. The guide closure part 40 is connected to the cylinder tube 30 by the first laser ring weld seam 71 in a positive substance manner. Furthermore, the base closure part 50 is also connected to the cylinder tube 30 in a positive substance manner by means of the second laser ring weld seam 72. And the pressure capsule 21 of the damping accumulator 20 is welded by means of the electron beam ring weld seam 22.

FIG. 2 and FIG. 3 each show an enlarged section of the base closure part side area of the hydraulic cylinder 10 in a preferred embodiment. The cylinder tube 30 has a conical ring surface 34, which adjoins a distally protruding end portion 33. The conical receiving contour 54 is located opposite the conical ring surface 34 with the same angle of conicity. The second laser ring weld seam 72 is arranged on the joining surface between the conical ring surface 34 and the conical receiving contour 54, and has, in accordance with the conicity, a laser weld seam inclination angle a of approximately 30 degrees in the exemplary embodiment.

The distally protruding end portion 33 is significantly tapered relative to the full cylinder tube wall thickness, as existing in the remaining areas, and also has a slight excess length. This makes it possible to preload the end portion 33 by means of elastic compression before the second laser ring weld seam 72 is produced. The axial ring surface 35 and the axial mating ring surface 55 abut against each other. Furthermore, the radial outer lateral surface 36 and the radial inner lateral surface 56 are opposite each other so that, at high pressures, the end portion 33, which is designed to be tapered for the elastic preload, comes into pressure contact to the radial inner lateral surface 56 and is supported by the latter

FIG. 4 shows the base closure part side area of the hydraulic cylinder 10 in another enlarged section in a preferred embodiment. The guide closure part has a graduated hollow-cylindrical receiving contour 41 at the connection point to the cylinder tube 30 so that the radial outer ring surface 42 of the guide closure part 40 and the guide-side inner lateral surface 37 of the cylinder tube 30 are opposite each other in the radial direction, and the proximal axial ring surface 43 of the guide closure part and the guide-side axial mating ring surface 38 are opposite each other in the axial direction. The proximal axial ring surface 43 and the guide side axial mating ring surface 38 form a butt joint. The first laser ring weld seam 71 is arranged there in a radial orientation—shown by the dashed line.

### REFERENCE NUMERALS

10 Hydraulic cylinder
20 Damping accumulator
21 Pressure capsule
22 Electron beam ring weld seam
30 Cylinder tube
31 Guide-side cylinder tube end
32 Base-side cylinder tube end
33 Protruding end portion
34 Conical ring surface
35 Axial ring surface
36 Radial outer lateral surface
37 Guide-side inner lateral surface
38 Guide-side axial mating ring surface
40 Guide closure part
41 Graduated hollow-cylindrical receiving contour
42 Radial outer ring surface
43 Proximal axial ring surface
50 Base closure part
51 Cylinder tube receiving portion
52 Damping accumulator receiving portion
53 Fluid channel
54 Concial receiving contour
55 Axial mating ring surface
56 Radial inner lateral surface
60 Piston unit
71 First laser ring weld seam
72 Second laser ring weld seam
α Laser weld seam inclination angle

1-4. (canceled)

5. A damping cylinder assembly, comprising:
a hydraulic cylinder having a cylinder tube, a guide closure part, a base closure part and a piston unit, said cylinder tube having a guide-side cylinder tube end and a base-side cylinder tube end, said guide closure part being arranged at said guide-side cylinder tube end;
a damping accumulator having a damping accumulator fluid connection and a pressure capsule having a fluid chamber and a pressure-deformable air chamber separated from said fluid chamber by a diaphragm;
said base closure part having a cylinder tube receiving portion, a damping accumulator receiving portion, and a fluid channel connecting said cylinder tube receiving portion and said damping accumulator receiving portion;
said cylinder tube arranged with said base-side cylinder tube end at said cylinder tube receiving portion, said piston unit slidingly passing through said guide closure part, said piston unit together with said cylinder tube and said base closure part, defining a working chamber connected to said fluid channel,
said damping accumulator fluid connection being arranged at the base closure part, said damping accumulator fluid connection being connected to said fluid channel;
said pressure capsule having an electron beam ring weld seam,
said guide closure part connected to said cylinder tube in a positive substance manner by a first circumferential laser ring weld seam, said base closure part connected to said cylinder tube in a positive substance manner by a second circumferential laser ring weld seam.

6. The damping cylinder assembly according to claim 5, wherein said cylinder tube receiving portion has a conical receiving contour, said cylinder tube has a conical ring surface that corresponds to said conical receiving contour, said second laser ring weld seam has a laser weld seam inclination angle which is 20 to 70 degrees, and said cylinder tube has an end portion that protrudes from said conical ring surface in an axially distal manner and said end portion has an axial ring surface that abuts against an axial mating ring surface of said cylinder tube receiving portion.

7. The damping cylinder assembly according to claim 6, wherein said end portion has a wall thickness of 10 to 30 percent of a wall thickness of said cylinder tube and a radial outer lateral surface which abuts against a radial inner lateral surface of said cylinder tube receiving portion.

8. The damping cylinder assembly according to claim 5, wherein said guide closure part has s a graduated hollow-cylindrical receiving contour, said hollow-cylindrical receiving contour has a radial outer ring surface that abuts against a guide-side inner lateral surface of said cylinder tube, and said guide closure part has a proximal axial ring surface that together with a guide-side distal axial mating ring surface of said cylinder tube, defines said first laser ring weld seam in a butt-jointed manner.
